(19) United States
(12) Patent Application Publication
(10) Pub. No.: US 2021/0244006 A1
(43) Pub. Date: Aug. 12, 2021

(54) Solar Automatic Air Pump

(71) Applicant: Chinedu Nnabugo Moneke, Lexington Park, MD (US)

(72) Inventor: Chinedu Nnabugo Moneke, Lexington Park, MD (US)

(21) Appl. No.: 17/099,944

(22) Filed: Nov. 17, 2020

Related U.S. Application Data
(60) Provisional application No. 62/940,026, filed on Nov. 25, 2019.

(51) Int. Cl. A01K 63/04; H02S 10/20; H02J 7/35; H02J 7/34; F04B 37/10; F04B 35/04

(52) U.S. Cl. CPC A01K 63/042; H02S 10/20; F04B 35/04; H02J 7/345; F04B 37/10; H02J 7/35

(57) ABSTRACT

The use of small solar cells for automatic aeration of systems is currently unavailable due to the tow efficiency of solar cells. With my invention, this would become possible. With this innovative design and setup, a very cost-effective automatic solar air pump can be used in different applications and systems. The solar air pump can work even on cloudy days and would have stored energy to work at night.

Solar Cells and Panels have power absorption limitations and are less efficient if the Solar Panel is not tilted in right way to the Sun to absorb the maximum amount of Solar Energy. They are also limited and inefficient during cloudy and rainy days. Dust and shading also reduces the energy and power absorption of Solar Panels.

In a small-scale application, for example with a Solar Panel with an area of 5.5 inches×4.5 inches, it is normally very difficult for the Solar Panel to power gadgets and appliances.

I decided to first focus on the Air Pump system for aquariums, aquaponic systems, hydroponic systems, bore holes and Irrigation.

### INTENT

The goal of this design is to create the most efficient, cost effective solar automatic air/water pump.

### INTRODUCTION

Different types of systems need air/water pump for aeration. These systems include aquariums, hydroponics, aquaponics, well water systems, tank water systems amongst others.

Solar Energy in one form or another is the source of nearly all energy on the earth. Solar cells, like plants extract this energy directly and uses the energy to power devices. Renewable forms of energy are essential in today's world especially now the earth is experiencing harmful effects caused by the burning of fossil fuels.

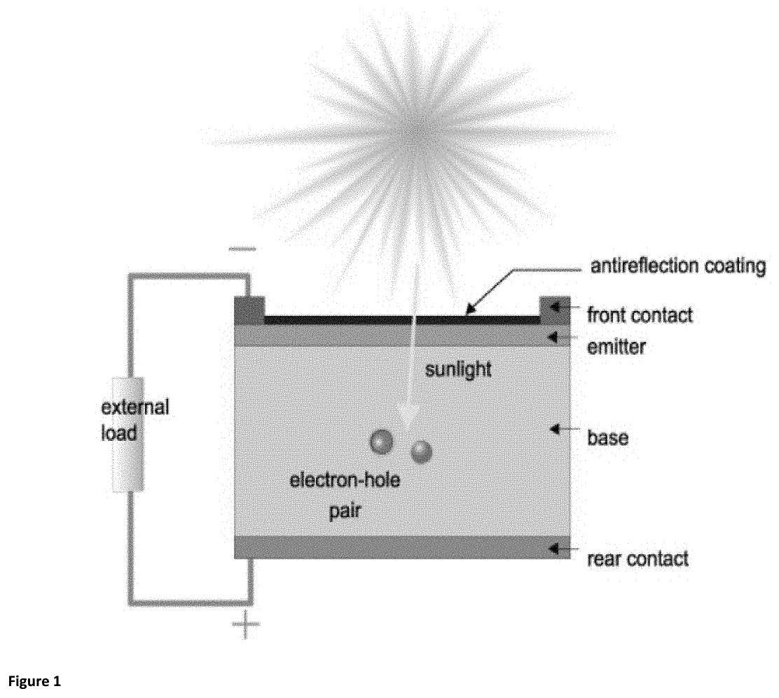

FIG. 1: Operation of a Solar Cell

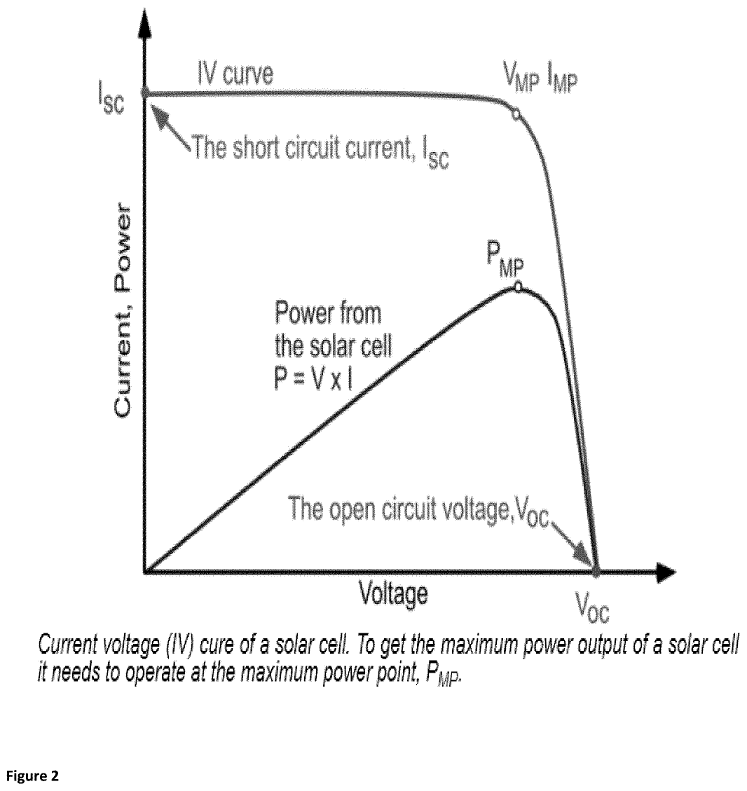

FIG. 2: Current Voltage (IV) curve of a Solar Cell

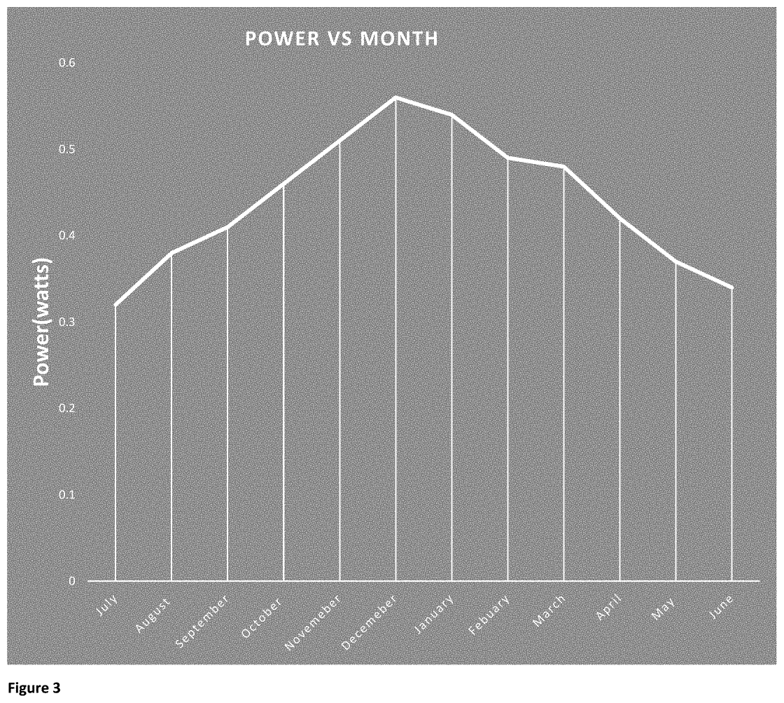

FIG. 3: Average monthly power

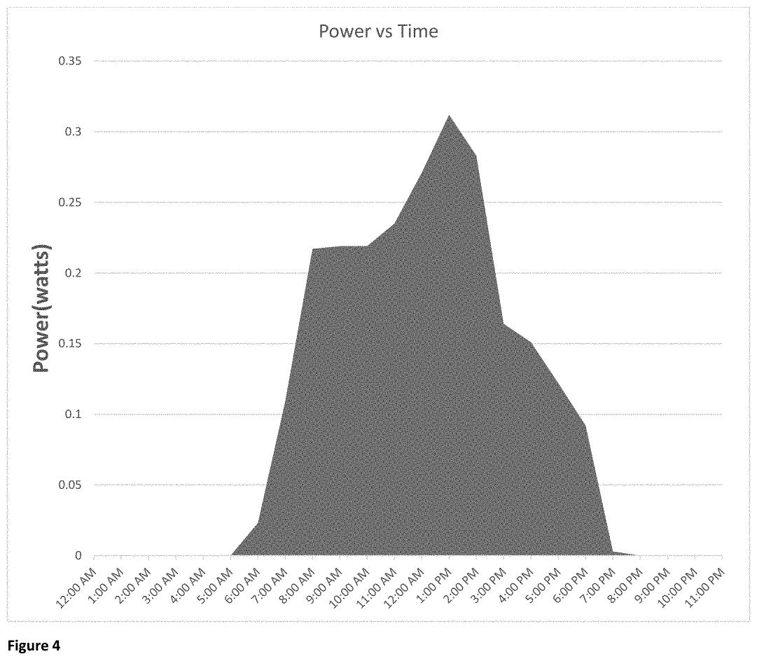

FIG. 4: Average hourly power

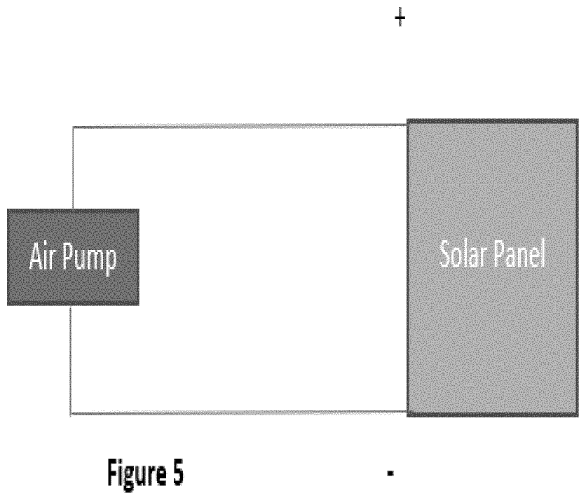

FIG. 5: Direct connection of Solar Panel to air pump

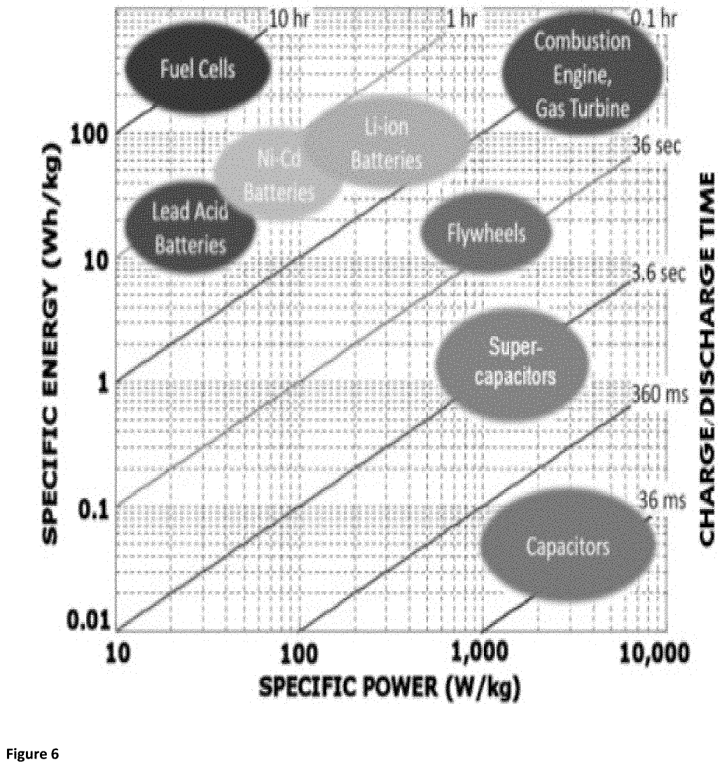

FIG. 6: Specific energy, Specific power & charge/discharge time of different storage types

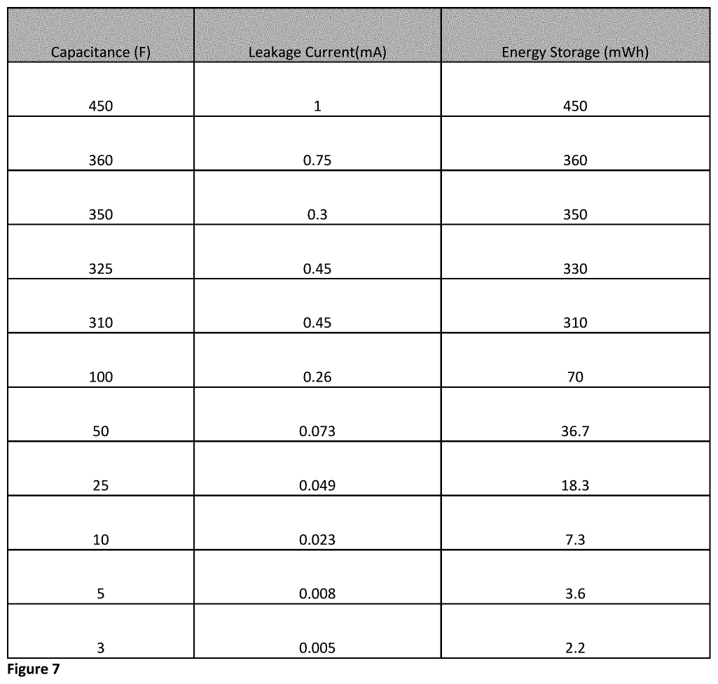

FIG. 7: Leakage current and energy storage of different capacitors

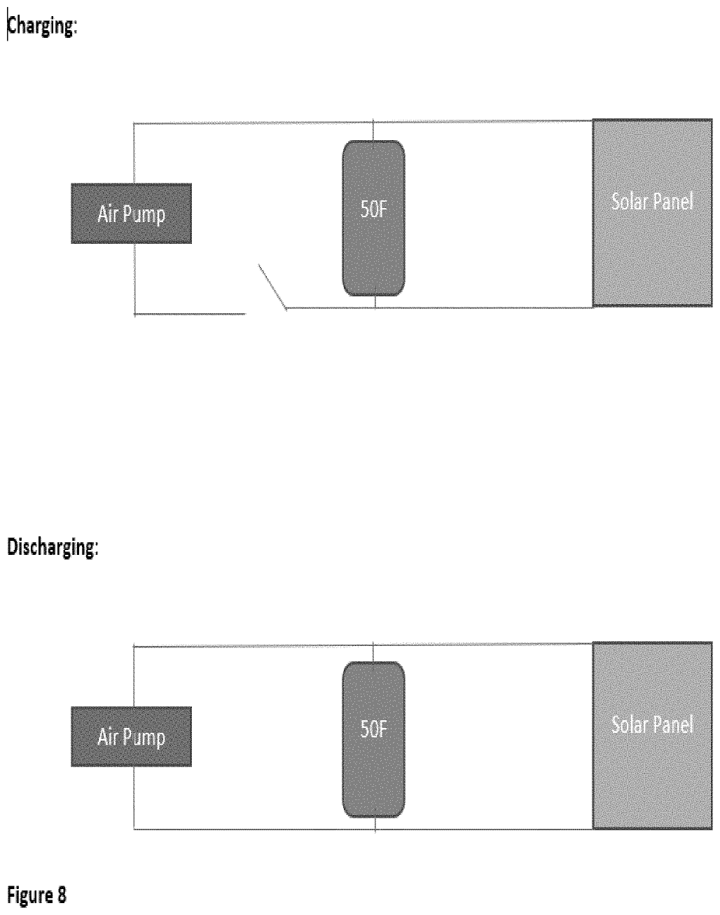

FIG. 8: Charging and Discharging phase of the Solar Air Pump

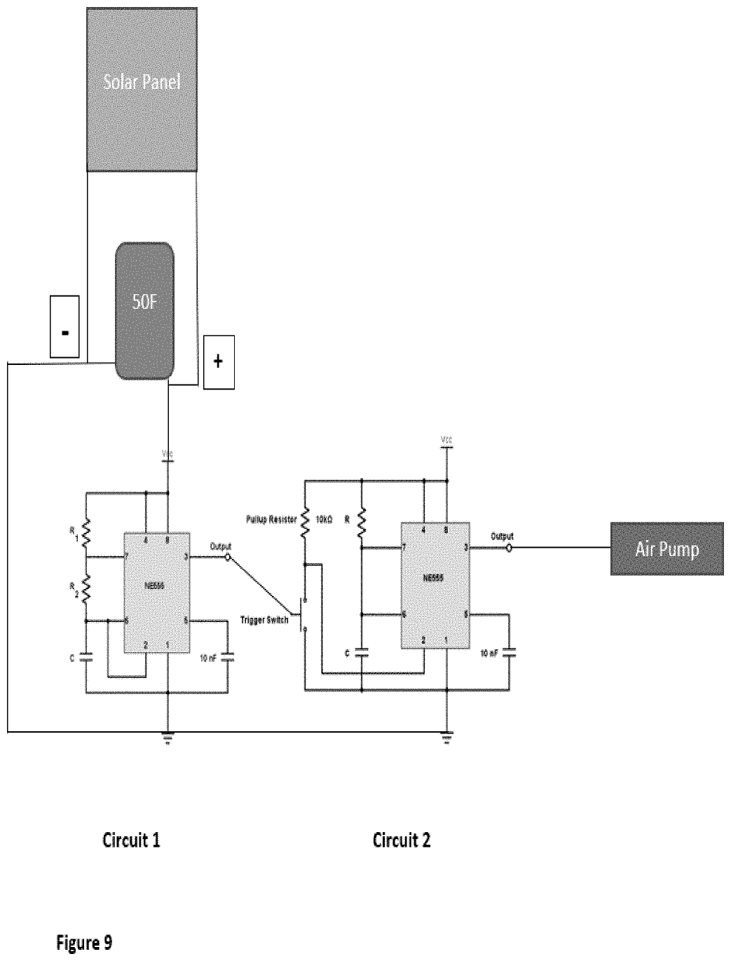

FIG. 9: Extraction Mechanism Design

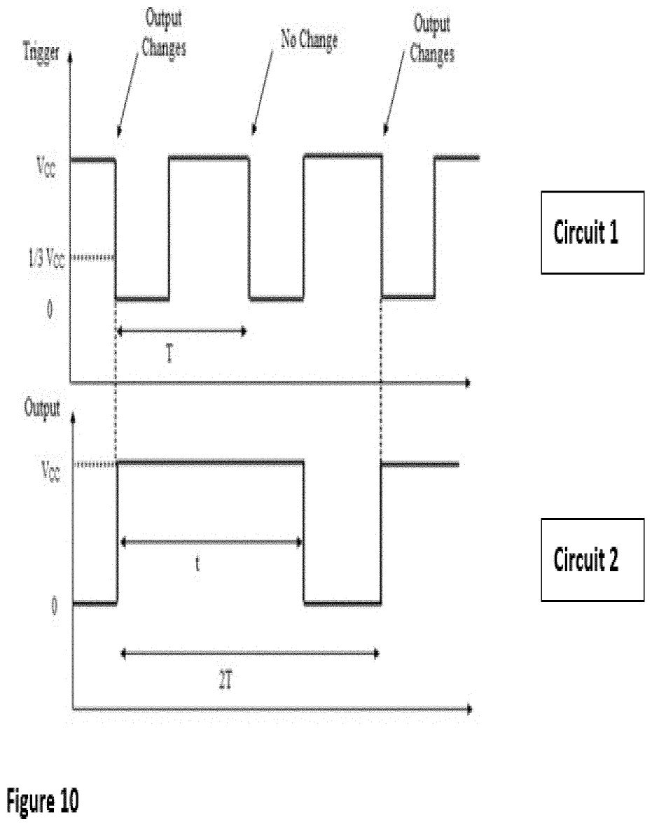

FIG. 10: Circuit 1 and Circuit 2 design

### SPECIFICATION

Design of the Automatic Solar Ari Pump

Phase 1:

DC Air Pump

The first objective during the research process was to obtain the lowest powered DC air pump available in the market. The DC air pump is the device that pumps air into the system.

Two parameters were key during testing of the DC powered air pump:
1) Startup voltage
2) Startup current

Power=Voltage×Current

The smaller the startup voltage, the smaller the solar panel.

The smaller the current, the smaller the energy storage system.

Numerous DC air pumps were tested using a voltmeter and multimeter. A variable DC adapter in connection with a potentiometer was used as the power source to vary the voltage supplied to the DC motors. Three of the best results are shown below:

YI Hardaware (YYP03)

| | |
|---|---|
| 2.7 V | 0.23A |

TCS Electrical (JQB243)

| | |
|---|---|
| 3.5 V | 0.46 |

ZHEN Precision (ZT030)

| | |
|---|---|
| 3.8 V | 0.39 |

Power
0.62 W
1.61 W
1.48 W

The YI Hardware was the best DC air pump that was suitable for the design. It was also the least expensive amongst the three DC air pumps.

Phase 2:

Solar Panel Type:

Solar Cell:

A solar cell is an electronic device which directly converts sunlight into electricity. Light shining on the solar cell produces both a current and a voltage to generate electric power. This process requires firstly, a material in which the absorption of light raises an electron to a higher energy state, and secondly, the movement of this higher energy electron from the solar cell into an external circuit. The electron then dissipates its energy in the external circuit and returns to the solar cell. A variety of materials and processes can potentially satisfy the requirements for photovoltaic energy conversion, but in practice nearly all photovoltaic energy conversion uses semiconductor materials in the form of a p-n junction. See FIG. 1.

The basic steps in the operation of a solar cell are:
The generation of light-generated carriers.
The collection of the light-generated carries to generate a current.
The generation of a large voltage across the solar cell; and
The dissipation of power in the load and in parasitic resistances.

Efficiency and Solar Cell Cost:

IV Curve:

In FIG. 6, The IV curve of a solar cell is the superposition of the IV curve of the solar cell diode in the dark with the light-generated current. The light has the effect of shifting the IV curve down into the fourth quadrant where power can be extracted from the diode. Illuminating a cell adds to the normal “dark” currents in the diode so that the diode law becomes:

$$I = {I}_{0} [ exp ( \frac{qV}{nkT} ) - 1 ] - {I}_{L}$$

where I_{L}=light generated current.

The effect of light on the current-voltage characteristics of a p-junction.

The equation for the IV curve in the first quadrant is:

$$I = {I}_{L} - {I}_{0} [ exp ( \frac{qV}{nkT} ) - 1 ]$$

The −1 term in the above equation can usually be neglected. The exponential term is usually >>1 except for voltages below 100 mV. Further, at low voltages, the light generated current I_{L} dominates the I₀ ( . . . ) term so the −1 term is not needed under illumination.

$$I = {I}_{L} - {I}_{0} [ exp ( \frac{qV}{nkT} ) ]$$

Plotting the above equation gives the IV curve below with the relevant points on the curve labeled and discussed in more detail on the following pages. The power curve has a maximum denoted as P_{MP} where the solar cell should be operated to give the maximum power output. It is also denoted as P_{MAX} or maximum power point (MPP) and occurs at a voltage of V_{MP} and a current of I_{MP}. See FIG. 2.

Solar Cell Efficiency:

The efficiency is the most used parameter to compare the performance of one solar cell to another. Efficiency is defined as the ratio of energy output from the solar cell to input energy from the sun. In addition to reflecting the performance of the solar cell itself, the efficiency depends on the spectrum and intensity of the incident sunlight and the temperature of the solar cell. Therefore, conditions under which efficiency was carefully controlled to compare the performance of one device to another. Terrestrial solar cells are measured under AM1.5 conditions and at a temperature of 25° C. Solar cells intended for space use are measured under AM0 conditions. Recent top efficiency solar cell results are given in the page Solar Cell Efficiency Results.

The efficiency of a solar cell is determined as the fraction of incident power which is converted to electricity and is defined as:

$${P}_{max} = {V}_{OC} {I}_{SC} FF$$

$$η = \frac{{V}_{OC} {I}_{SC} FF}{{P}_{in}}$$

Where:

Voc is the open-circuit voltage;

Isc is the short-circuit current;

FF is the fill factor and

η is the efficiency.

Under laboratory conditions and with current state-of-the-art technology, it is possible to produce single crystal silicon solar cells close to 25% efficient. However, commercially mass-produced cells are typically only 13-14% efficient. The overriding reason for this difference in efficiency is that the research techniques used in the laboratory are not suitable for commercial production within the photovoltaic industry and therefore lower cost techniques, which result in lower efficiency, are used.

A 15% single(mono) crystalline 6V solar panel was used in this research with following features shown below:

Voltage: 6V

Length: 0.14 m

Width: 0.11 m

Area: 0.0154 m²

Cost: $14.65

The solar module was tested all through the year at the worst-case orientation and inclination.

Orientation of Solar Panel: None (Flat on the surface)

Tilt of Solar Panel: 0 degrees

The average power for each month was calculated. See FIG. 3. A minimum power of 0.31 W was achieved in July.

The average hourly power during the month of July was calculated and tabulated in the chart in FIG. 4.

It could be seen that the maximum power output from the solar module in the month of July was 0.31 watts while the minimum input required from the most efficient air pump was 0.62 watts.

Setup 1:

The solar panel was connected directly to the air pump, but the air pump did not come on which was expected. See FIG. 5.

Powering the air pump would require an increase in either the efficiency of the solar panel or the size of the solar panel or both. There were far less limitations in increasing the size of the solar panel.

Different 6V solar panels at 15% efficiency were tested under the same conditions in the month of July and the size, power and cost were calculated and shown below:

| Area(m²) | Power(W) | Cost ($) |
|---|---|---|
| 0.0231 | 0.45 | 39 |
| 0.0396 | 0.58 | 59 |
| 0.0550 | 0.68 | 79 |
| 0.1053 | 1.93 | 129 |

It was seen that a $79 solar panel was minimum solar panel that could power the 0.62 watt air pump. This would not be cost efficient especially for small scale aquarium applications.

### IDEA AND INNOVATION

The idea was to still use the 0.0154 m² ($14.65) solar panel but to have an inbuilt mechanism that extracts the energy supplied by the solar panel and store it in a storage system. Then when the power reaches the 0.62 W, the inbuilt mechanism would supply the power to the air pump. When the power goes below the 0.62 W power threshold, the mechanism closes, and the cycle repeats again.

Storage Mechanism:

Different storage mechanisms were tested.

Battery:

The battery has the best energy density but performed poorly on power density. A minimum threshold voltage and power was also required before the battery begins to charge. The charging rate was also very slow due to the chemical reactions within.

Supercapacitor:

The supercapacitor was the most ideal for the design. Even though it had a lower energy density than the battery, it had an excellent power density and could extract even the smallest amount of energy supplied by the solar panel. This was a needed feature during cloudy days. Supercapacitors have faster charge rates than batteries because the chemical reactions that take place within batteries take longer to release electrons than the electrical charge in supercapacitors. This was useful during sunrise, sunset, cloudy and rainy days.

The chart of the different storage types is shown in FIG. 6 below:

Capacitance:

The two key features that were used in determining the right capacitance were the leakage current and the storage capacity.

The leakage current and storage capacity was tested for different values of capacitance and the results were tabulated below.

In FIG. 7, The lowest possible leakage current was desirable, but the storage capacity was important as well. A compromise was made with the 50F capacitor because it had a relatively low leakage current and still had enough storage capacity to power the air pump at night.

Extraction Process and Timing:

In FIG. 8, In the charging phase, the solar panel was connected in parallel with the capacitor and air pump, with an open circuit at the air pump connection. The system was tested under the worst-case scenario (cloudy days). On average it took 2.38 mins for the solar panel to charge the capacitor to the point (0.62 W) where it had enough power to power the air pump.

In the discharging phase, when the circuit was closed, it took 25 seconds for the capacitor to power the air pump before going below the threshold power (0.62 W) of the air pump.

Extraction Mechanism:

In FIG. 9, the extraction mechanism compromises of a 555 timer in combination with capacitors and resistor. The mechanism acts as a gated system which opens and closes in the processes described below:
Gate closes for 3 mins for the capacitor to build enough power to activate the air pump.
Gate opens after the threshold has been met and allows current to flow through the air pump.
Gate closes again as soon as the power is below the threshold power of the air pump.
The cycle repeats again.

In FIG. 10, In Circuit 1 is designed to oscillate and act like a trigger for Circuit 2.

The tin Circuit 2 corresponds to the time that the gate stays open.

The time the gate stays closed is represented as (2T−t)

Circuit 1:

The frequency is the number of pulses per second. The formula to calculate the frequency of the output voltage is:

$$f = \frac{1.44}{( {R}_{1} + 2 {R}_{2} ) C}$$

The period is the time covered for one pulse. This is just the reciprocal of the frequency:

$$T = \frac{1}{f} = 0.694 ( {R}_{1} + 2 {R}_{2} ) C$$

The high time (T₁) and low time (T₀) can be calculated using the formulas below. Note that the period is the sum of the high time and the low time.

The mark space ratio is the ratio between the high time and the low time or:

$$Mark Space Ratio = \frac{{T}_{1}}{{T}_{0}}$$

The duty cycle is more commonly used than the mark space ratio. The formula for the duty cycle is:

$$Duty Cycle = \frac{{T}_{1}}{T} \times 100$$

R₁=10 megaohms

R₂⁼10 kilohms

C=47 micro farad

Circuit 2:

The formula for the Output Pulse Width (t) in circuit 2 is given as:

T=1.1×R×C.

As shown in the formula, the output pulse width is determined only by the resistor and capacitor combination.

R=10 kilohms

C=500 micro farads.

1. My intention was to be able to use a small-scale solar panel for automatic aeration of systems. To achieve this, I created an inbuilt mechanism that extracts the energy supplied by the solar panel and store it in a storage system. Then when the power reaches the 0.62 W, the Inbuilt mechanism would supply the power to the air pump. When the power goes below the 0.62 W power threshold, the mechanism closes, and the cycle repeats again.
With this innovative design and setup, a very cost-effective small scale solar air pump can be used in different applications and systems. The solar air pump can work even on cloudy days and would have stored energy to work at night.
Looking at the air pump needed for Aquariums, It normally has a minimum input power needed to operate. For a small-scale Solar Panel like the 5.4 inches×4.4 inches, it was difficult to power the necessary pump because of the limitations mentioned above. With my invention and design process, it can now power the pump.
The key is for the Solar Panel system to rather harvest and store the energy from the Daylight/Sun until the output power of the Solar Panel system reaches the input power of the pump. The gate of the IC chip is closed during this process. Once this power has been reached, the gate opens, and power is then released to the pump. As the stored output power falls below that of the input power of the pump, the gate of the IC chip closes and the and the absorption of energy begins again. The cycle repeats indefinitely and is automatic as well.
The energy is stored in an Ultra Capacitor. Capacitors have an advantage of storing energy very fast. They also absorb very small amounts of energy which is suited for the Solar Panel system during cloudy and rainy days. The energy stored in the Capacitor is also used to power the pumps all through the night into the daytime until the energy absorption begins again.
Electronics primarily used are the 555 timer, capacitors, and resistors. The resistors, smaller capacitors and the two 555 timers are the programing entities and Power Gate Keepers. The 555 timer has a gate that opens and closes delivering power to the system or holding back power until the threshold is reached. The resistors also limit and regulate the flow of current.
